(19) United States
(12) Patent Application Publication
(10) Pub. No.: US 2026/0200223 A1
(43) Pub. Date: Jul. 16, 2026

(54) FILM PASTING AUXILIARY DEVICE, FILM PASTING DEVICE, AND FILM PASTING ASSEMBLY

(71) Applicant: Shenzhen Zhongxincheng Technology Co., Ltd, Shenzhen (CN)

(72) Inventor: Canglong Tu, Shenzhen (CN)

(73) Assignee: Shenzhen Zhongxincheng Technology Co., Ltd, Shenzhen (CN)

(21) Appl. No.: 19/286,265

(22) Filed: Jul. 31, 2025

(30) Foreign Application Priority Data
Jan. 16, 2025 (CN) 2025201055537
Jul. 9, 2025 (CN) 2025214275855

(51) Int. Cl. B32B 38/18; B32B 37/18

(52) U.S. Cl. CPC B32B 38/18; B32B 37/18; B32B 2457/208

(57) ABSTRACT

The present invention relates to a film pasting auxiliary device, a film pasting device, and a film pasting assembly. The film pasting auxiliary device comprises a positioning base defining a receiving groove for a protective film and an opening groove at one side of the positioning base in communication with the receiving groove. A plurality of support pads protrude from the bottom wall of the receiving groove. The protruding height of the support pads farther from the opening groove is greater than that of the support pads closer to the opening groove, so that the protective film is inclined after being placed. The relatively higher end of the protective film will first contact the screen of the electronic device, and the lower end will gradually adhere to the screen along with gas exhausting, thereby fully allowing bubbles to be fully expelled for optimal adhesion.

### TECHNICAL FIELD

The present disclosure relates to the technical field of protective films for mobile terminals such as smartphones and tablets, and more particularly to a film pasting auxiliary device, a film pasting device, and a film pasting assembly.

### BACKGROUND

In daily life, to protect the screens of smartphones, smartwatches, tablet computers, etc., from scratches and cracks, protective films are generally applied on the screen surfaces.

In a typical solution, a film pasting auxiliary device has been developed to improve the precision of film application. This device comprises a positioning base defining a cavity groove for receiving electronic devices. The bottom of the cavity groove defines a receiving groove for placing a protective film. An opening groove is defined at one side of the positioning base and is in communication with the cavity groove. When applying a film to an electronic device, the protective film is first placed into the receiving groove of the auxiliary device. The shape of the receiving groove matches the protective film, thereby achieving a positioning function to the protective film. Subsequently, the electronic device is placed into the cavity groove, with the screen side of the electronic device pressed against the protective film. Then, a handle on the protective film is pulled, causing a release film on the protective film to be pulled out from the opening groove, accordingly achieving automatic attachment of the protective film.

In the above-mentioned film pasting auxiliary device, due to the weight of the electronic device, the screen of the electronic device is in close contact with the protective film, leaving insufficient air exhaust space between the screen and the protective film, which can easily result in the generation of gas bubbles during film pasting. In addition, the bottom wall of the receiving groove is attached to and supports the protective film. When the receiving groove deforms, the bottom wall of the receiving groove will become uneven, and the protective film placed in the receiving groove will also be uneven, which can adversely affect the smoothness of the film.

### SUMMARY OF THE INVENTION

Therefore, a film pasting auxiliary device, a film pasting device, and a film pasting assembly are provided, to solve the problems in the background mentioned above.

A film pasting auxiliary device is provided, which comprises a positioning base defining a receiving groove for placing a protective film and an opening groove at one side of the positioning base in communication with the receiving groove. A bottom wall of the receiving groove is provided with a plurality of support pads which protrude from the bottom wall of the receiving groove. The protruding height of the part of the support pads farther from the opening groove is greater than that of the other part of the support pads closer to the opening groove, so that the protective film is inclined after being placed in the receiving groove.

Preferably, the top of the receiving groove is provided with a cavity groove for receiving an electronic device. The bottom of the cavity groove is provided with a plurality of positioning protrusions, which support the electronic device. The protrusion height of the part of the positioning protrusions far from the opening groove is smaller than that of the other part of the positioning protrusions near the opening groove, so that the electronic device is inclined after being placed in the cavity groove. The side walls of the positioning protrusions define the side walls of the receiving groove.

Preferably, a support platform is formed at a bottom of the opening groove and are higher than the bottom wall of the receiving groove. The support platform cooperating with the positioning protrusions defines a placing space for placing the protective film.

Preferably, the positioning base is provided with a plurality of exhaust grooves, which is communicated to the cavity groove and the receiving groove. The positioning protrusions is arranged alternately with the exhaust grooves.

Preferably, the support pads comprises at least one first support pad and at least one second support pad, both of which are arranged in a strip shape and parallel to each other.

Preferably, the bottom wall of the receiving groove is configured to be flat, and the protruding height of the first support pad is 1 mm to 2 mm, while the protruding height of the second support pad is 0.5 mm to 1.3 mm.

Preferably, the positioning base has a first end and a second end that are opposite to each other. The opening groove is defined at the first end, and the second end of the positioning base is provided with a yielding groove for placing ear of the protective film.

Further, the present application provides a film pasting device, which comprises a packaging box and the above-mentioned film pasting auxiliary device, wherein the positioning base is received inside the packaging box.

Preferably, the packaging box comprises a main body and a cover plate. The positioning base is fixed on the main body, and the cover plate is configured to cover onto the cavity groove. A set of positioning pressure strips is provided on a face of the cover plate facing towards the cavity groove.

Furthermore, the present application still provides a film pasting assembly which comprises a protective film and the film pasting device as described above. The protective film comprises an adhesive film and a release film, wherein the adhesive film has a protective surface and an adhesive surface, and the release film is adhered to the adhesive surface. One end of the release film protrudes from the adhesive surface to form the ear, and the other end protrudes from the adhesive surface to form a pull tab. When the protective film is placed in the receiving groove, the adhesive film faces downwards and the release film faces upwards, and the ear is positioned in the yielding groove. The pull tab is exposed out of the opening groove, and a pull-out label is provided on the release film.

The present application has advantages as follows:

1. By setting the height difference of the two parts of the support pads, the protective film is inclined relative to the electronic device after placement, so as to raise the protective film to one side high and the other side low, forming a triangular exhaust space and a pulling space for the release film defining between the protective film and the electronic device screen. The relatively higher end of the protective film will first come into contact with the screen of the electronic device, and static electricity will be generated during the process of removing the release film. The lower end will gradually adhere to the screen due to static electricity along with gas exhausting. As it is a single-sided exhaust, there is no risk of trapped air, thereby fully allowing gas bubbles to be fully expelled for optimal adhesion. At the same time, due to the height increasing effect of the support pads, even if the bottom of the receiving groove deforms and bulges, it does not affect the attachment flatness of the film.

2. The positioning base has an exhaust groove, which communicates the cavity groove to the receiving groove. When the receiving groove receives the protective film and the cavity groove receives the electronic device, the exhaust groove can more easily allow external gas to enter the cavity, balance the internal and external pressure of the chamber, and avoid negative pressure adsorption, which is more benefit for the film pasting.

3. The side of the cover plate facing the cavity groove is equipped with a set of positioning pressure strips, which can position the electronic device when wiping the screen. In addition, when the cover plate is closed, the positioning pressure strip can also seal the opening groove, preventing the film accessories placed in the receiving groove from slipping down from the opening groove.

In order to describe the technical solutions in the embodiments of the present disclosure more clearly, the following briefly describes the accompanying drawings required for describing the embodiments. Apparently, the accompanying drawings in the following description show merely some embodiments of the present disclosure, and those of ordinary skill in the art may still derive other drawings from these accompanying drawings without creative labor.

### BRIEF DESCRIPTION OF DRAWINGS

FIG. 1 is a schematic perspective view of the whole structure of a film pasting auxiliary device according to an embodiment of the present invention;

FIG. 2 is a schematic perspective view of the whole structure of a film pasting device according to an embodiment of the present invention;

FIG. 3 is an enlarged view of part A in FIG. 1;

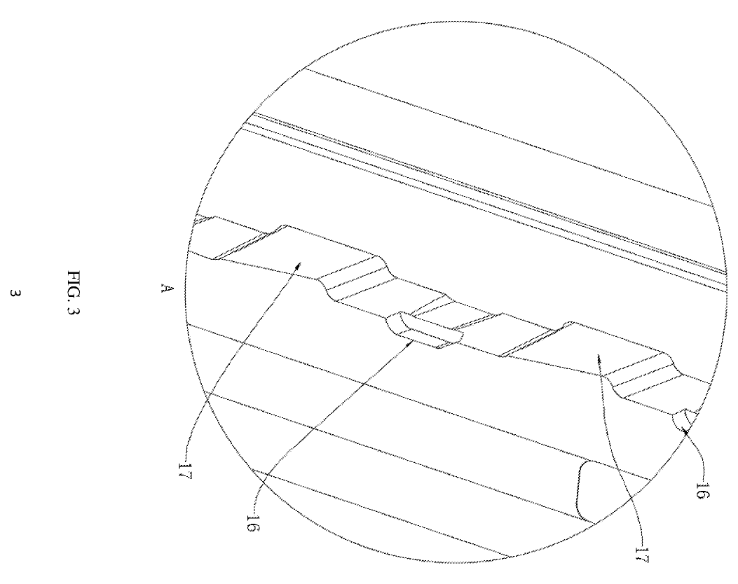

FIG. 4 is a schematic perspective view of the whole structure of a film pasting assembly according to an embodiment of the utility model;

FIG. 5 is a schematic perspective view of the film pasting status of the film pasting assembly according to the embodiment of the present invention.

Reference numeral description:

1. Positioning base; 101. First end; 102. Second end; 11. Receiving groove; 111. Third support pad; 12. Opening groove; 121. Support platform; 122. Positioning sidewall; 13. First support pad; 14. Second support pad; 15. Cavity groove; 16. Positioning protrusion; 17. Exhaust groove; 18. Yielding groove; 19. Finger slot; 20. Packaging box; 21. Main body; 22. Cover plate; 23. Positioning pressure strip; 30. Protective film; 31. Ear; 32. Pull tab; 40. Electronic device.

### DETAILED DESCRIPTION OF THE INVENTION

The technical solution in embodiments of the present disclosure will be clearly and completely described below with reference to the embodiments of the present disclosure. Apparently, the described embodiments are merely a part, rather than all of the embodiments, of the present disclosure. On the basis of the embodiments in the present disclosure, all other embodiments acquired by those of ordinary skill in the art without creative labor also fall within the scope of protection of the present disclosure.

It is to be noted that all directional indications or positional relationships in the embodiments, for example, center, upper, lower, left, right, vertical, horizontal, inner, outer, and the like, are based on the orientation or positional relationships shown in the accompanying drawings. These terms are merely used for explaining relative position relations, moving conditions, and the like among components in a certain special gesture, rather than indicating or implying that the referred device or component must have a specific orientation or be constructed and operated in a specific orientation. Therefore, these terms should not be seemed as limiting the scope of the present application. Furthermore, the terms, for example, first, second, and third are used for descriptive purposes only and should not be interpreted as indicating or implying relative importance.

In the present disclosure, unless otherwise specified and defined, the terms “connect”, “fix”, and the like shall be understood in a broad sense. For example, “fix” can be fixedly connection or detachable connection or integrated connection; mechanical connection or electrical connection; or direct connection or indirect connection through an intermedium, and internal communication of two components or an interactive relationship of the two components, unless otherwise defined. Those of ordinary skill in the art may understand the specific meanings of the terms in the present disclosure under specific circumstances.

In addition, the technical solutions of the embodiments of the present disclosure may be combined with one another based on implementation by those of ordinary skill in the art. When the technical solutions contradict each other in combination or may not be realized, it is to be considered that there is no combination of the technical solutions, which shall not fall into the protection scope of the present disclosure.

Embodiment 1

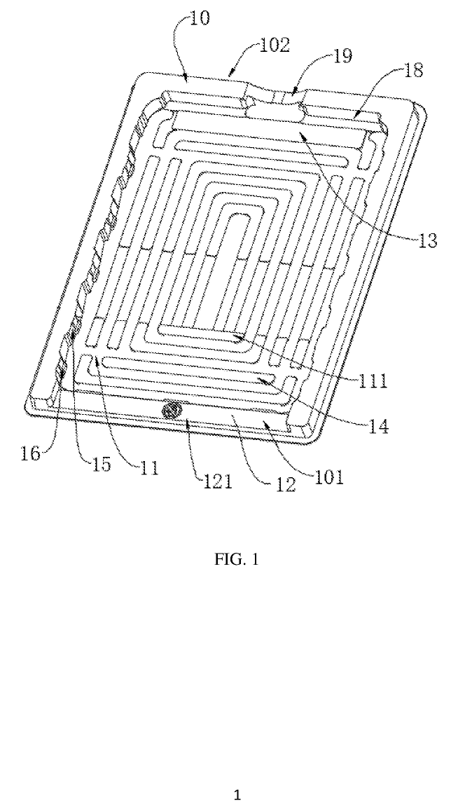

Referring to FIG. 1, a film pasting auxiliary device according to an embodiment of the present invention is illustrated. The film pasting auxiliary device comprises a positioning base 10 defining a receiving groove 11 for placing a protective film 30 and an opening groove 12 at one side of the positioning base 10 in communication with the receiving groove 11. A bottom wall of the receiving groove 11 is provided with a plurality of support pads which protrude from the bottom wall of the receiving groove 11. The protruding height of the part of the support pads farther from the opening groove is greater than that of the other part of the support pads closer to the opening groove, so that the protective film 30 is inclined after being placed in the receiving groove 11.

By setting the height difference of the two parts of the support pads, the protective film 30 is inclined relative to the electronic device 40 after placement, so as to raise the protective film 30 to one side high and the other side low, forming a triangular exhaust space and a pulling space for the release film defining between the protective film 30 and the screen of the electronic device 40. The relatively higher end of the protective film 30 will first come into contact with the screen of the electronic device 40 and static electricity will be generated during the process of removing the release film. The lower end will gradually adhere to the screen due to static electricity along with gas exhausting. As it is a single-sided exhaust, there is no risk of trapped air, thereby fully allowing bubbles to be fully expelled for optimal adhesion. At the same time, due to the height increasing effect of the support pads, even if the bottom of the receiving groove 11 deforms and bulges, it does not affect the attachment flatness of the film.

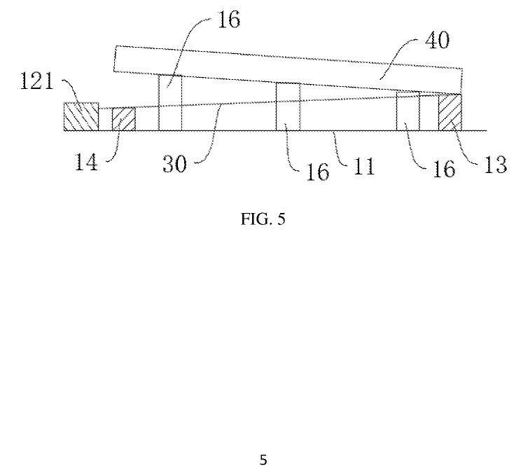

Preferably, the support pads comprises at least one first support pad and at least one second support pad, both of which are arranged in a strip shape and parallel to each other. Preferably, the bottom wall of the receiving groove 11 is configured to be flat, and the protruding height of the first support pad is 1 mm to 2 mm, more preferably 1.5 mm. The protruding height of the second support pad is 0.5 mm to 1.3 mm, more preferably 1.0 mm. Preferably, the top of the receiving groove 11 is provided with a cavity groove 15 for receiving an electronic device 40. The bottom of the cavity groove 15 is provided with a plurality of positioning protrusions 16, which support the electronic device 40. The protrusion height of the part of the positioning protrusions 16 far from the opening groove 12 is smaller than that of the other part of the positioning protrusions 16 near the opening groove 12, so that the electronic device 40 is inclined after being placed in the cavity groove 15. The side walls of the positioning protrusions 16 define the side walls of the receiving groove 11. A triangular exhaust space is defined between the protective film 30 and the screen of the electronic device 40. As shown in FIG. 5, the part of the protective film 30 far from the opening groove 12 will first attached to the screen of the electronic device 40 and static electricity will be generated during the process of removing the release film. Then, along with peeling of the release film, the protective film 30 will gradually adhere to the screen while air bubbles are fully expelled, until the whole protective film 30 completely adhere to the screen. As shown in FIG. 5, the tilted protective film 30 can form a triangular exhaust space with respect to the tilted screen of the electronic device 40 in order to fully expel air bubbles. Additionally, the triangular space formed between the tilted protective film 30 and the tilted screen of the electronic device 40 provides sufficient space for pulling the release film, thereby preventing jamming during the pulling process and improving the film pasting efficiency.

In a preferred embodiment, a support platform 121 are formed at a bottom of the opening groove 12 and are higher than the bottom wall of the receiving groove 11. The support platform 121 cooperating with the positioning protrusions 16 defines a placing space for placing the protective film 30.

Due to the height difference between the supporting platform 121 and the bottom wall of the receiving groove 11, when the protective film 30 is placed into the receiving groove 11 and the release film is removed to perform the film pasting operation on the electronic device 40, the supporting platform 121 acts as a bar and positioning function, so as to prevent the protective film 30 from being pulled out across the opening groove 12. This ensures the smooth progress of the film pasting process. In contrast, traditional film pasting devices require installation of positioning posts on the device and corresponding positioning holes on the protective film to achieve positioning action during the film pasting process. The present film pasting auxiliary device in this embodiment is free of such positioning posts and holes, resulting in a simplified structure and reduced cost.

In another preferred embodiment, the top surfaces of the plurality of positioning protrusions 16 are configured to form an identical plane. As such, after the electronic device 40 is placed in the cavity groove 15, through support of the positioning protrusions 16, the electronic device 40 could be horizontally positioned. Accordingly, the tilted protective film 30 and the screen of the electronic device 40 form a triangular exhaust space and a pulling space for the release film.

In an embodiment, a third support pad 111 is provided on a middle position of the bottom wall of the receiving groove 11. The protrusion height of the third support pad 111 is less than that of the first support pad 13 and the second support pad 14, respectively. The protrusion height of the third support pad 111 is preferably 0.5 mm. When the protective film 30 is placed in the receiving groove 11, the middle position at the bottom of the protective film 30 is in a suspension state. This allows external gas to readily enter the bottom of the protective film 30, facilitating the balance of internal and external pressure, avoiding generation of negative pressure adsorption, preventing any impact on the film pasting effect, and thus making it easier to remove the protective film 30 from the receiving groove 11.

Preferably, the positioning base 10 is provided with a plurality of exhaust grooves 17, through which the cavity groove 15 is communicated to the receiving groove 11. The positioning protrusions 16 is arranged alternately with the exhaust grooves 17. The exhaust grooves 17 facilitates easier entry of external gas into the cavity, thereby improving the film pasting process. In this embodiment, the exhaust grooves 17 is located on the side walls of the cavity groove 15 and the receiving groove 11. To ensure uniform exhaust, the plurality of exhaust grooves 17 are arranged circumferentially around the mold cavity groove 15. The positioning protrusions 16 is arranged alternately with the exhaust grooves 17, forming a rational layout.

In an alternative embodiment, the exhaust groove 17 could, e.g., be an independent hole-shaped structure. The exhaust grooves 17 are directly defined on the positioning base 10, communicating the cavity groove 15 and the receiving groove 11, thereby enabling exhaust functionality.

Preferably, the positioning base 10 has a first end 101 and a second end 102 that are opposite to each other. The opening groove 12 is defined at the first end 101, and the second end 102 of the positioning base 10 is provided with a yielding groove 18 for placing ear 31 of the protective film 30.

Specifically, the protective film 30 could be, e.g., a tempered glass film. The protective film 30 comprises an adhesive film and a release film, the adhesive film has a protective surface and an adhesive surface, and the release film is adhered to the adhesive surface. One end of the release film protrudes from the adhesive surface to form the ear 31, and the other end protrudes from the adhesive surface to form a pull tab 32. When the protective film 30 is placed in the receiving groove 11, the adhesive film faces downwards and the release film faces upwards, and the ear 32 is positioned in the yielding groove 18. The pull tab 32 is exposed out of the opening groove 12, and a pull-out label is provided on the release film, prompting the user to perform a pull-out operation. After placing the electronic device 40 into the cavity groove 15, a triangular space is formed between the protective film 30 and the electronic device 40. The higher end of the protective film 30 will first contact the screen of the electronic device 40, while the lower end of the protective film 30 will gradually adhere to the electronic device 40 along with expelling air due to the self-weight of the electronic device 40. When the adhesive film initially contacts one end of the screen, air expulsion will slowly proceed from that end toward the other end, achieving uniform air expulsion and resolving the issue of air entrapment during tempered film attachment. Since the air expulsion occurs in a single direction, there is no risk of trapped air.

Further, a buffer airbag is provided inside the receiving groove 11 to protect the protective film 30. Since the protective film 30 is a tempered glass film, it requires protection to prevent cracking and damage. A buffer airbag with an annular protrusion is directly arranged on the bottom wall of the receiving groove 11, ensuring that the protective film 30 is safer within the receiving groove 11 and less susceptible to damage from external impacts.

Preferably, the positioning base 10 is provided with a finger groove 19, which communicates with the cavity groove 15. The finger groove 19 is defined at the second end 102 of the positioning base 10, allowing fingers to extend into the finger groove 19 and directly contact the electronic device 40, thereby facilitating removal of the electronic device 40 after accomplishing film pasting process.

The opening groove 12 comprises two positioning sidewalls 122, with a distance between them being smaller than a width of the cavity groove 15. This ensures the positioned fixation of the installed electronic device 40, preventing it from sliding out of the opening groove 12 during the film pasting process, which could otherwise compromise the film pasting effect.

Embodiment 2

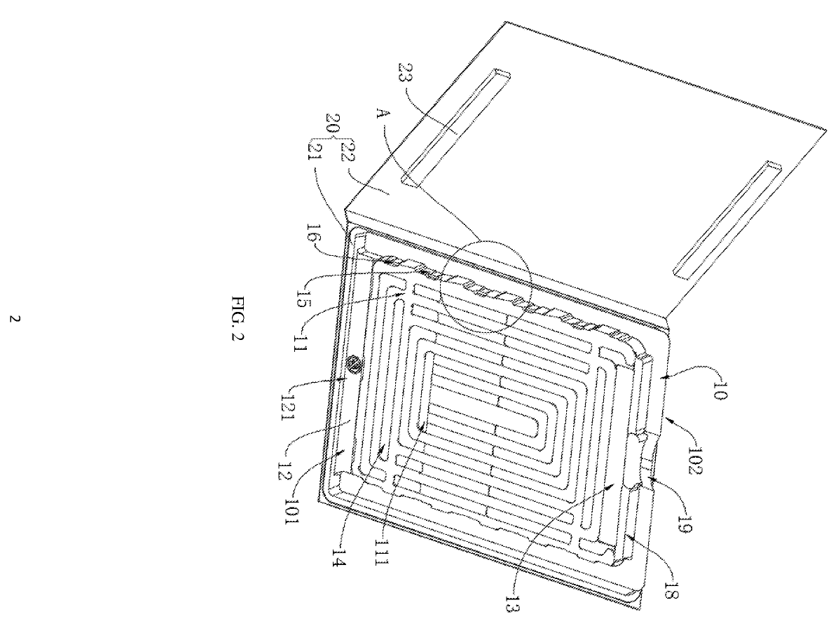

Referring to FIG. 2, the present application according to an embodiment provides a film pasting device, which comprises a packaging box 20 and the film pasting auxiliary device as described in Embodiment 1. The positioning base 10 is received inside the packaging box 20. The positioning base 10 could be disposed inside the packaging box 20, e.g., by a snap-fit manner, or an adhesive manner.

Specifically, the packaging box 20 comprises a main body 21 and a cover plate 22. The positioning base 10 is fixed on the main body 21, e.g., by an adhesive manner. During pasting film, the cover plate 22 could cover onto the cavity groove 15 and the electronic device 40 is positioned by the cover plate 22, thereby causing the film pasting process easier to perform.

A set of positioning pressure strips 23 is provided on a face of the cover plate 22 facing towards the cavity groove 15. As such, this forms a positioning action to the position of the electronic device 40 when wiping the screen. Additionally, when the cover plate 22 cover onto the cavity groove 15, the positioning pressure strips 23 can also seal the opening groove 12, preventing the film accessories placed in the receiving groove 11 from sliding out through the opening groove 12.

Embodiment 3

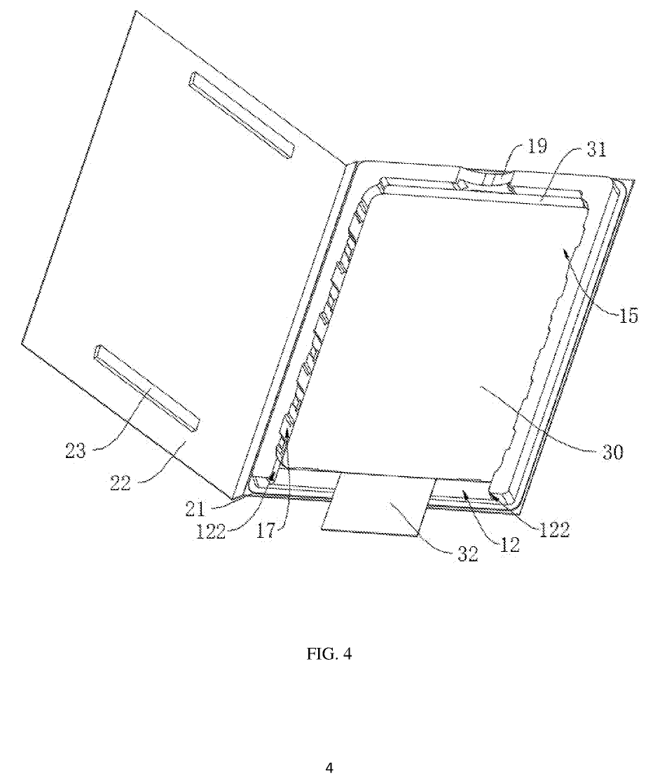

Referring to FIG. 4, the present application according to an embodiment provides a film pasting assembly, which comprises a protective film 30 and the film pasting device as described in Embodiment 2. The protective film 30 could be, e.g., a tempered glass film. The protective film 30 comprises an adhesive film and a release film, wherein the adhesive film has a protective surface and an adhesive surface, and the release film is adhered to the adhesive surface. One end of the release film protrudes from the adhesive surface to form the ear 31, and the other end protrudes from the adhesive surface to form a pull tab 32. When the protective film 30 is placed in the receiving groove 11, the adhesive film faces downwards and the release film faces upwards, and the ear 31 is positioned in the yielding groove 18. The pull tab 32 is exposed out of the opening groove 12, and a pull-out label is provided on the release film for prompting the user to perform a pull-out operation.

In this embodiment, the protective film 30 and the film pasting device are products sold synchronously. The protective film 30 is placed in the receiving groove 11, and the positioning base 10 is directly packaged using the packaging box 20. In this way, the film pasting auxiliary device functions as a protective case, providing protection for the protective film 30, eliminating the need for an additional protective sleeve. When pasting the film to the electronic device 40, the protective film 30 is firstly placed in the receiving groove 11, with the adhesive side facing downwards and the release film facing upwards, ensuring the ear 31 is positioned in the yielding groove 18 and the pull tab 32 protrudes from the opening groove 12. Subsequently, the electronic device 40 is place d into the cavity groove 15, pressing the screen side of the electronic device 40 against the protective film 30. After placing the electronic device 40, the protective film 30 and the electronic device 40 form a triangular space. Pulling the pull tab 32 causes the release film to dissociate from the adhesive film and be pulled out from the opening groove 12. The adhesive surface of the adhesive film is exposing outside. The higher end will first contact and adhere to the screen of the electronic device 40, while the lower end will gradually adhere to the electronic device 40 along with expelling air due to the self-weight of the electronic device 40, achieving uniform air exhaust. This resolves the issue of air entrapment during tempered film application and enables automatic adhesion of the protective film 30.

Compared with the traditional arts, the protrusion height of the first support pad 13 is greater than that of the second support pad 14, causing the protective film 30 to tilt relative to the placed electronic device 40 after placement, thereby elevating the protective film 30 with one side higher and the other lower. The higher end of the protective film 30 will first contact the screen of the electronic device 40. During the process of removal off the release film, static electricity will be generated, and the lower end will gradually adhere to the screen due to static electricity along with gas exhausting. Since the air expulsion occurs in a single direction, there is no risk of trapped air, allowing gas bubbles to be fully removed and achieving excellent adhesion. Additionally, due to the applied height effect of the first support pad 13 with respect to the second support pad 14, even if deformation-induced protrusions occur at the bottom of the receiving groove 11, the flatness of the pasted film remains unaffected.

The above is only a preferred embodiment of the disclosure and does not impose any formal limitations on it. Therefore, any simple modifications, equivalent changes, and modifications made to the above embodiments base 10d on the technical essence of the disclosure, which are not separated from the technical solution of the disclosure, shall fall within the scope of protection of the technical solution of the disclosure.

What is claimed is:

1. A film pasting auxiliary device, comprising a positioning base (10) defining a receiving groove (11) for placing a protective film (30), and an opening groove (12) at one side of the positioning base (10) in communication with the receiving groove (11), wherein a bottom wall of the receiving groove (11) is provided with plurality of supporting pads, all of which protrude from a bottom wall of the receiving groove (11), wherein the protruding height of the part of the supporting pads farther from the opening groove (12) is greater than that of the other part of supporting pads closer to the opening groove (12), so that the protective film (30) is inclined after being placed in the receiving groove (11).

2. The film pasting auxiliary device according to claim 1, wherein the top of the receiving groove (11) is provided with a cavity groove (15) for receiving an electronic device (40), and the bottom of the cavity groove (15) is provided with plurality of positioning protrusions (16) for supporting the electronic device (40), the protruding height of the part of the positioning protrusions (16) farther from the opening groove (12) is less than that of the other part of the positioning protrusions (16) closer to the opening groove (12), so that the electronic device is inclined after being placed in the cavity groove (15), and the side walls of the positioning protrusions (16) define the side walls of the receiving groove (11).

3. The film pasting auxiliary device according to claim 2, wherein a support platform (121) is formed at a bottom of the opening groove (12) and protrudes from the bottom wall of the receiving groove (11), and the support platform (121) cooperates with the positioning protrusion (16) to form a placement space for the protective film (30).

4. The film pasting auxiliary device according to claim 2, wherein the positioning base (10) is provided with a plurality of exhaust grooves (17), which is communicated to the cavity groove (15) and the receiving groove (11).

5. The film pasting auxiliary device according to claim 2, wherein the support pads comprises at least one first support pad (13) and at least one second support pad (14), both the first support pad (13) and the second support pad (14) are strip-shaped and arranged parallel to each other.

6. The film pasting auxiliary device according to claim 4, wherein the bottom wall of the receiving groove (11) is configured to be flatten, the protrusion height of the first support pad (13) is 1mm to 2mm, and the protrusion height of the second support pad (14) is 0.5mm to 1.3mm.

7. The film pasting auxiliary device according to claim 1, wherein the positioning base (10) comprises a first end (101) and a second end (102) opposite to each other, the opening groove (12) is disposed at the first end (101), and the second end (102) of the positioning base (10) is provided with a yielding groove (18) for placing the ear (31) of the protective film (30).

8. A film pasting device, comprising a packaging box (20) and the film pasting auxiliary device according to claim 1, the positioning base (10) being placed in the packaging box (20).

9. The film pasting device according to claim 8, wherein the top of the receiving groove (11) is provided with a cavity groove (15) for receiving an electronic device (40), and a bottom of the cavity groove (15) is provided with plurality of positioning protrusions (16) for supporting the electronic device (40), the protruding height of the part of the positioning protrusions (16) farther from the opening groove (12) is less than that of the other part of the positioning protrusions (16) closer to the opening groove (12), so that the electronic device is inclined after being placed in the cavity groove (15), and the side walls of the positioning protrusions (16) define the side walls of the receiving groove (11).

10. The film pasting device according to claim 9, wherein a support platform (121) is formed at a bottom of the opening groove (12) and protrudes from the bottom wall of the receiving groove (11), and the support platform (121) cooperates with the positioning protrusion (16) to form a placement space for the protective film (30).

11. The film pasting device according to claim 9, wherein the positioning base (10) is provided with a plurality of exhaust grooves (17), which is communicated to the cavity groove (15) and the receiving groove (11).

12. The film pasting device according to claim 9, wherein the support pads comprises at least one first support pad (13) and at least one second support pad (14), both the first support pad (13) and the second support pad (14) are strip-shaped and arranged parallel to each other.

13. The film pasting device according to claim 12, wherein the bottom wall of the receiving groove (11) is configured to be flatten, the protrusion height of the first support pad (13) is 1mm to 2mm, and the protrusion height of the second support pad (14) is 0.5mm to 1.3mm.

14. The film pasting device according to claim 8, wherein the positioning base (10) comprises a first end (101) and a second end (102) opposite to each other, the opening groove (12) is disposed at the first end (101), and the second end (102) of the positioning base (10) is provided with a yielding groove (18) for placing the ear (31) of the protective film (30).

15. The film pasting device according to claim 8, wherein the packaging box (20) comprises a main body (21) and a cover plate (22), the positioning base (10) is fixed on the main body (21), the cover plate (22) is configured to cover onto the cavity groove (15), and one side of the cover plate (22) facing the cavity groove (15) is provided with a set of positioning pressure strips (23).

16. A film pasting assembly, comprising a protective film (30) and the pasting device according to claim 8, the protective film (30) comprising an adhesive film and a release film, the adhesive film having a protective surface and an adhesive surface, the release film being adhered to the adhesive surface, one end of the release film protruding from the adhesive surface to form an ear (31), and the other end protruding from the adhesive surface to form a pull tab (32), when the protective film (30) is placed in the receiving groove (11), the adhesive film faces downward, the release film faces upward, the ear (31) is positioned in the yielding groove (18), the pull tab (32) is exposed out of the opening groove (12), and a pull-out label is provided on the release film.
